(19) United States
(12) Patent Application Publication
(10) Pub. No.: US 2010/0309524 A1
(43) Pub. Date: Dec. 9, 2010

(54) JOB PROCESSING APPARATUS, CONTROL METHOD, AND STORAGE MEDIUM

(75) Inventor: Takeshi Suwabe, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/864,227

(22) PCT Filed: Mar. 18, 2009
(86) PCT No.: PCT/JP2009/056022

§ 371 Date: Jul. 22, 2010

(30) Foreign Application Priority Data
Mar. 26, 2008 (JP) 2008-081743

(51) Int. Cl. G06F 3/12

(52) U.S. Cl. 358/1.15

(57) ABSTRACT

The present invention provides a job processing apparatus which allows a plurality of users to log in, the apparatus including a detection unit configured to detect that a plurality of users has logged in, an accepting unit configured to accept a job execution instruction from a user, a display unit configured to, when the detection unit detects that a plurality of users has logged in, display the plurality of logged-in users so as to be able to identify a user who issues a job execution instruction to be accepted by the accepting unit, among the plurality of logged-in users, and a processing unit configured to, when the user is identified based on the display by the display unit and the accepting unit accepts the job execution instruction, execute a job corresponding to the execution instruction as a job by the identified user.

### TECHNICAL FIELD

The present invention relates to a job processing apparatus, control method, and storage medium.

### BACKGROUND ART

There has conventionally been known a terminal which is shared between a plurality of users (see Japanese Patent Laid-Open No. 11-25040). In many cases, when one user logs in to the terminal, another user cannot use it.

To solve this, a multi-login environment receives a great deal of attention. The multi-login environment provides an environment which allows a plurality of users to simultaneously log in to a job processing apparatus such as an image forming apparatus (or image forming system), and execute jobs.

The multi-login environment allows a user to log in to an image forming apparatus while maintaining the login environment of another user who has first logged in to the image forming apparatus. In the multi-login environment, a plurality of users can log in to an image forming apparatus and execute jobs such as printing while sharing (browsing) their knowledge (e.g., documents saved in the image forming apparatus) between them.

In an environment where a plurality of users who have logged in to an image forming apparatus execute jobs in front of the operation unit, a user who actually executed a job sometimes cannot be identified. In this case, correct job owner information may not be stored in a log which saves job results, or a third party user (account) may be charged (the job count may be incremented).

However, a conventional technique cannot identify a user who designates execution of a job unless logged-in users are limited to one by prompting logged-in users to log out. The login environments of logged-out users are reset, canceling the multi-login environment where users' knowledge (documents saved in the image forming apparatus) can be shared (browsed). Hence, the conventional technique can identify neither a job owner in the multi-login environment, nor job owner information and the charging destination to be stored in the log. Since the login environment is reset, no job owner can be switched while browsing the knowledge of a logged-in user.

### DISCLOSURE OF INVENTION

The present invention provides a job processing apparatus capable of definitely identifying a user (job owner) who designates execution of a job in an environment where a plurality of users can log in.

According to one aspect of the present invention, there is provided a job processing apparatus which allows a plurality of users to log in, the apparatus includes a detection means configured to detect that a plurality of users has logged in, an accepting means configured to accept a job execution instruction from a user, a display means configured to, when the detection means detects that a plurality of users has logged in, display the plurality of logged-in users so as to be able to identify a user who issues a job execution instruction to be accepted by the accepting means, among the plurality of logged-in users, and a processing means configured to, when the user is identified based on the display by the display means and the accepting means accepts the job execution instruction, execute a job corresponding to the execution instruction as a job by the identified user.

Further features of the present invention will become apparent from the following description of exemplary embodiments with reference to the attached drawings.

### BRIEF DESCRIPTION OF DRAWINGS

FIG. 1 is a view showing the arrangement of an image forming apparatus according to an embodiment of the present invention.

FIG. 2 is a table showing an example of a table which is stored in the storage unit of the image forming apparatus shown in FIG. 1 and manages counter information.

FIG. 3 is a table showing an example of a table which is stored in the storage unit of the image forming apparatus shown in FIG. 1 and manages job log information.

FIG. 4 is a view showing an operation window displayed on the liquid crystal display of an operation unit when the image forming apparatus shown in FIG. 1 is activated.

FIG. 5 is a view showing an example of an operation window displayed on the liquid crystal display of the operation unit when a login key is pressed in the operation window shown in FIG. 4.

FIG. 6 is a view showing an example of an operation window displayed on the liquid crystal display of the operation unit after login processing is executed via the operation window shown in FIG. 5.

FIG. 7 is a view showing an example of an operation window displayed on the liquid crystal display of the operation unit after a plurality of login processes are executed via the operation window shown in FIG. 5.

FIG. 8 is a view showing an example of an operation window displayed on the liquid crystal display of the operation unit when a job key or shortcut key is pressed in the operation window shown in FIG. 7.

FIG. 9 is a view showing an example of an operation window displayed on the liquid crystal display of the operation unit when a batch print key in a pane whose owner is user “suzuki” is pressed in the operation window shown in FIG. 8.

FIG. 10 is a view showing an example of an operation window displayed on the liquid crystal display of the operation unit when a batch send key in the pane whose owner is user “suzuki” is pressed in the operation window shown in FIG. 8.

FIG. 11 is a view showing an example of an operation window displayed on the liquid crystal display of the operation unit when a batch read key in the pane whose owner is user “suzuki” is pressed in the operation window shown in FIG. 8.

FIG. 12 is a flowchart for explaining the operation of the image forming apparatus shown in FIG. 1.

FIG. 13 is a view showing an example of an operation window displayed on the liquid crystal display of the operation unit when a job key or shortcut key is pressed in the operation window shown in FIG. 7.

FIG. 14 is a flowchart for explaining the operation of the image forming apparatus shown in FIG. 1.

### BEST MODE FOR CARRYING OUT THE INVENTION

A preferred embodiment of the present invention will be described below with reference to the accompanying drawings. The same reference numerals denote the same parts throughout the drawings, and a repetitive description thereof will be omitted.

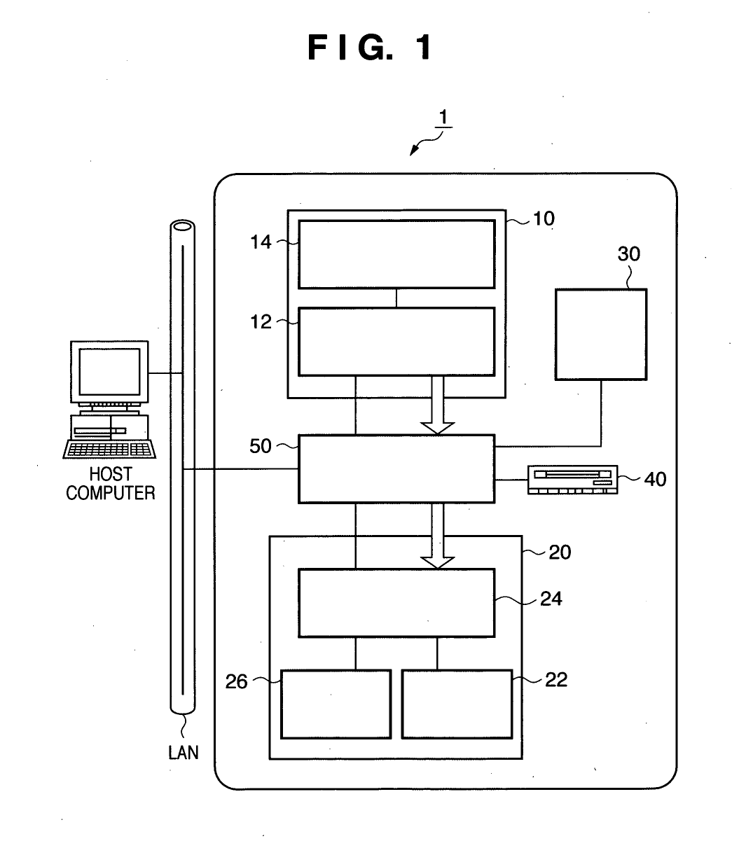

FIG. 1 is a view showing the arrangement of an image forming apparatus 1 (and an image forming system including the image forming apparatus 1) according to the embodiment of the present invention. The image forming apparatus 1 is a job processing apparatus which allows a plurality of users to log in. The image forming apparatus 1 provides a multi-login environment where the login states of a plurality of users are maintained. As shown in FIG. 1, the image forming apparatus 1 includes a reader unit 10, printer unit 20, operation unit 30, storage unit 40, and control unit 50.

The reader unit 10 optically scans a document to read an image on the document and convert it into image data representing the image. In the embodiment, the reader unit 10 includes a scanner 12 having a function of scanning a document, and a document feeder 14 having a function of conveying a plurality of set document sheets one by one. The scanner 12 scans a document sheet conveyed from the document feeder 14. The reader unit 10 may also read a document sheet set by the user on the platen glass and convert the image into image data without using the document feeder 14.

The printer unit 20 conveys a print sheet, forms (prints) image data as a visible image on the print sheet, and delivers the print sheet. In the embodiment, the printer unit 20 includes a paper source 22 including print sheet cassettes for storing various types of print sheets, an image forming unit 24 for transferring image data as a visible image onto a print sheet and fixing the image, and a delivery unit 26 for sorting and stapling print sheets bearing images, and delivering them.

The operation unit 30 includes a liquid crystal display, a touch panel (input device) formed on the liquid crystal display, and a plurality of hard keys. The operation unit 30 provides a user interface (UI) for performing a variety of operations by the user. In other words, the operation unit 30 functions as an accepting unit which accepts a job execution instruction from the user. The operation unit 30 transmits, to the control unit 50, a user instruction input via the touch panel and/or hard keys. The operation unit 30 displays, on the liquid crystal display, an image (e.g., an operation window) corresponding to image data transmitted from the control unit 50. The operation unit 30 and an operation window displayed on the operation unit 30 will be explained in detail later.

The storage unit 40 is formed from, for example, a hard disk (HD), and stores various programs and data associated with the operation of the image forming apparatus 1. The storage unit 40 includes a plurality of box areas as an area for storing image data. Each user can designate one of the boxes to store image data. In the embodiment, the storage unit 40 stores a table which manages information on a job executed by the image forming apparatus 1 for each of users who log in to the image forming apparatus 1. The storage unit 40 includes a storage area for storing a job log corresponding to each job, and a counter area used for charging and the like.

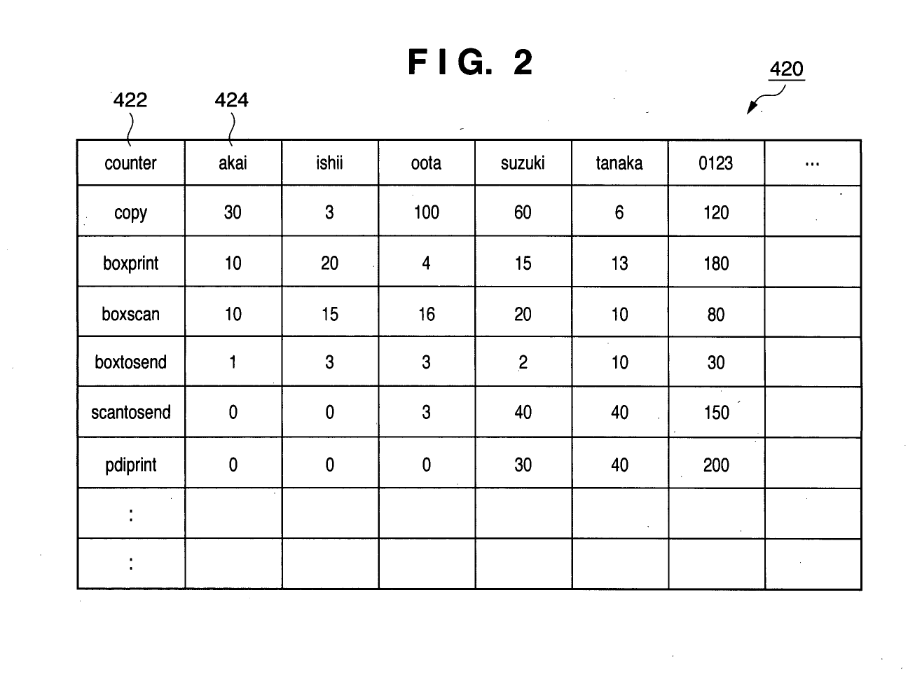

FIG. 2 is a table showing an example of a table 420 which is stored in the storage unit 40 and manages counter information. In the table 420, counter information representing the count at which jobs were executed is managed for each job and each user (including an individual and department). For example, the counter information can be used for charging, to limit the usable count, and to total the use count.

A job type area 422 represents the type of job executed by the image forming apparatus 1. In the embodiment, the job type area 422 represents copy, Box print (boxprint), Box scan (boxscan), BoxToSend (boxtosend), and the like as examples of a job. A copy job outputs, to the printer unit 20, image data obtained by reading an image on a document by the reader unit 10, and prints the image on a print sheet. A Box print job reads out a selected one of image data stored in a box in the storage unit 40, and prints the image on a print sheet by the printer unit 20. A Box scan job stores, in a box in the storage unit 40, image data obtained by reading an image on a document by the reader unit 10. A BoxToSend job reads out a selected one of image data stored in a box in the storage unit 40, and sends it outside. The transmission method is facsimile transmission, e-mail transmission, FTP transmission, or the like.

A user information area 424 represents information of a plurality of users who can log in to the image forming apparatus 1. In the embodiment, the user information area 424 represents akai, ishii, oota, and the like as examples of user information. User information represented in the user information area 424 is not limited to an individual, but may also be a department ID or the like.

By looking up the table 420, the count at which each user has executed each type of job can be graphed. For example, user “akai” has executed copy 30 times, Box print 10 times, Box scan 10 times, and BoxToSend once.

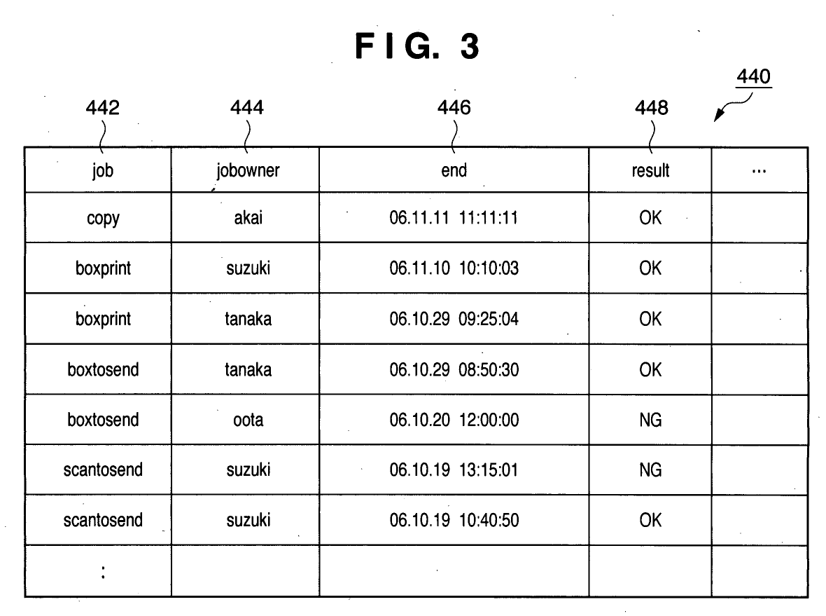

FIG. 3 is a table showing an example of a table 440 which is stored in the storage unit 40 and manages job log information. In the table 440, log information on execution of a job is managed for each job.

A job area 442 represents the type of job executed by the image forming apparatus 1.

A job owner (jobowner) area 444 represents a job owner as a user who designated execution of a job.

An end area 446 represents the end time of a job executed by the image forming apparatus 1.

A result area 448 represents a status of whether a job executed by the image forming apparatus 1 normally ended.

Referring back to FIG. 1, the control unit 50 includes a CPU and memory, and controls the operation of the image forming apparatus 1. The control unit 50 is electrically connected to the reader unit 10, printer unit 20, operation unit 30, and storage unit 40. The control unit 50 is also connected to a LAN connected to a host computer.

The control unit 50 controls the reader unit 10, printer unit 20, operation unit 30, and storage unit 40, and provides a copy function, Box function, network scanner function, printer function, and the like. The copy function reads an image on a document, converts it into image data, and forms (prints) an image corresponding to the image data on a print sheet. The Box function stores (saves) image data in a box in the storage unit 40, or prints and sends image data in a box. The network scanner function converts image data obtained by reading a document by the reader unit 10 into an image file, and transmits the image file to the host computer via the LAN. The printer function converts code data received from the host computer via the LAN into image data, and forms (prints) an image corresponding to the image data on a print sheet. The control unit 50 executes a variety of jobs by properly combining these functions in accordance with a job execution instruction from the user via the operation unit 30 or host computer.

In the embodiment, the control unit 50 also functions as a detection unit which detects that a plurality of users have logged in to the image forming apparatus 1, and an identifying unit which identifies, based on an operation on the operation unit 30, a user who is to execute a job. The control unit 50 also functions as a rewriting unit which, when a user who is to execute a job is identified, rewrites information on jobs by the identified user in the table 420 stored in the storage unit 40.

The operation unit 30 and an operation window displayed on the operation unit 30 will be explained. In the embodiment, the operation unit 30 displays a plurality of users who have logged in to the image forming apparatus 1, so as to be able to select (identify) a user who is to execute a job. In addition, the operation unit 30 displays, on the liquid crystal display, an operation window for accepting an operation to select a user who is to execute a job.

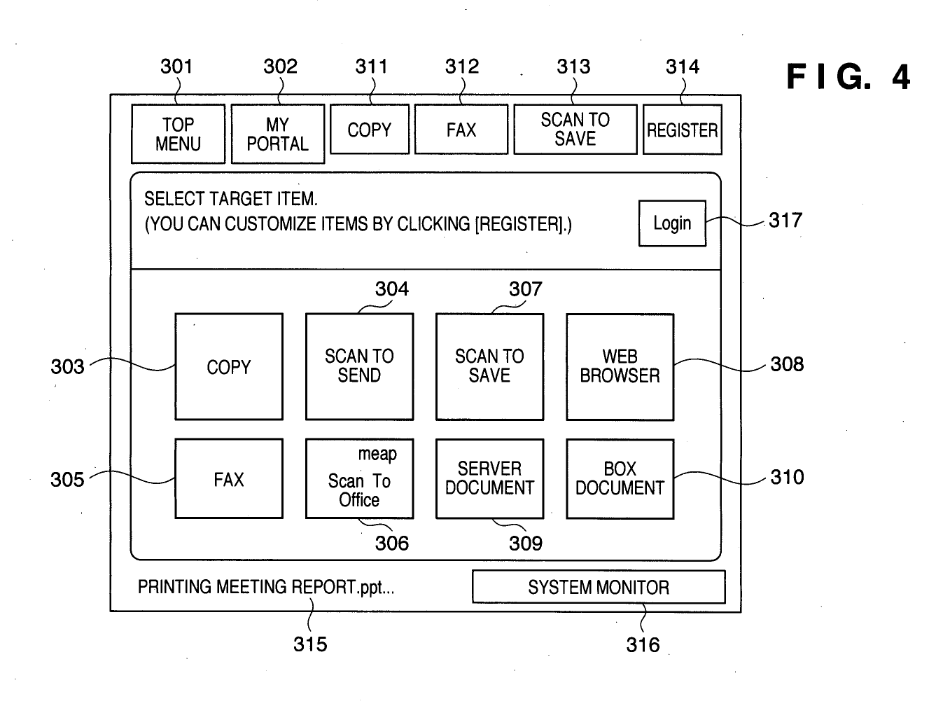

FIG. 4 is a view showing an operation window displayed on the liquid crystal display of the operation unit 30 when the image forming apparatus 1 is activated (i.e., in the initial state of the image forming apparatus 1). In FIG. 4, a top menu key 301 is pressed to return to the operation window of a top menu. A my portal key 302 is pressed to display a window which shows only information on a specific user (e.g., information of jobs executed by the specific user and a key unique to the specific user). Job keys 303 to 310 represent respective jobs. Shortcut keys 311 to 313 are shortcuts to respective jobs. A registration key 314 is used to register the shortcut keys 311 to 313. A status line 315 displays, for example, information of a job in execution, or information which prompts exchange of consumables (e.g., toner). A system monitor key 316 is pressed to display a window for browsing information on a list of jobs in execution, a job log list, or the like. A login key 317 is pressed to log in to the image forming apparatus 1.

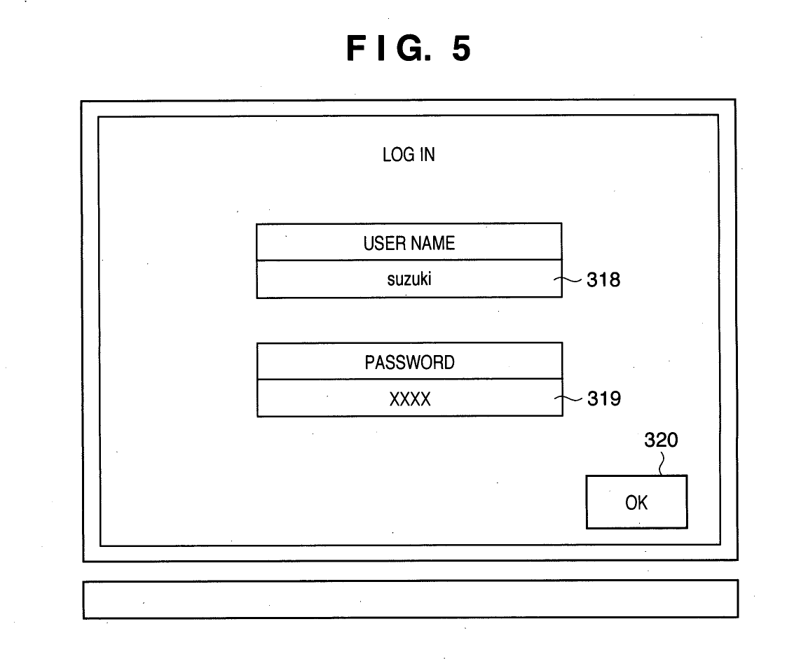

FIG. 5 is a view showing an example of an operation window (login window) displayed on the liquid crystal display of the operation unit 30 when the login key 317 is pressed in the operation window shown in FIG. 4. In FIG. 5, an input field 318 is used to input a user name, and “suzuki” or the like is input. An input field 319 is used to input a password. Reference numeral 320 denotes an OK key. When a user inputs a user name in the input field 318 and a password in the input field 319, and presses the OK key 320, login processing is executed.

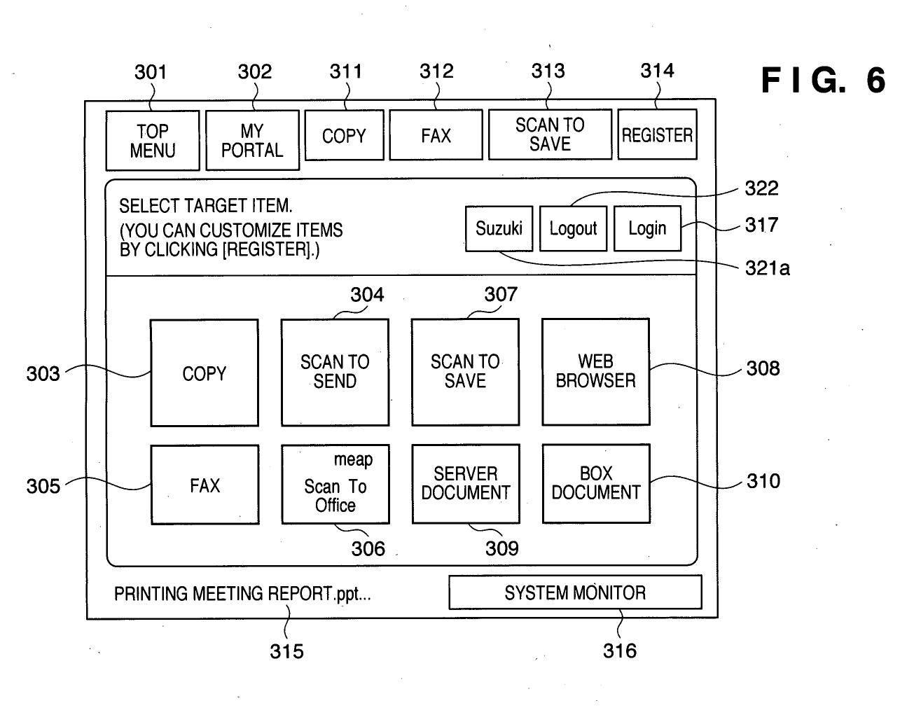

FIG. 6 is a view showing an example of an operation window displayed on the liquid crystal display of the operation unit 30 after login processing is executed via the operation window shown in FIG. 5 (i.e., after a user logs in to the image forming apparatus 1). The operation window shown in FIG. 6 is basically the same as that shown in FIG. 4 except that information 321a of a user (“suzuki” in the embodiment) who has logged in to the image forming apparatus 1 is displayed. The operation window shown in FIG. 6 also displays a logout key 322 pressed when a user who has logged in to the image forming apparatus 1 is to log out. In the operation window shown in FIG. 6, when the user presses one of the job keys 303 to 310 and shortcut keys 311 to 313, a corresponding operation window is displayed for user “suzuki”. In the operation window shown in FIG. 6, only one user has logged in to the image forming apparatus 1. Thus, when the user presses the logout key 322, the operation window returns to one shown in FIG. 4. By pressing the login key 317, another user can log in. In this case, an operation window (login window) displayed on the liquid crystal display of the operation unit 30 is identical to that shown in FIG. 5, and a detailed description thereof will not be repeated.

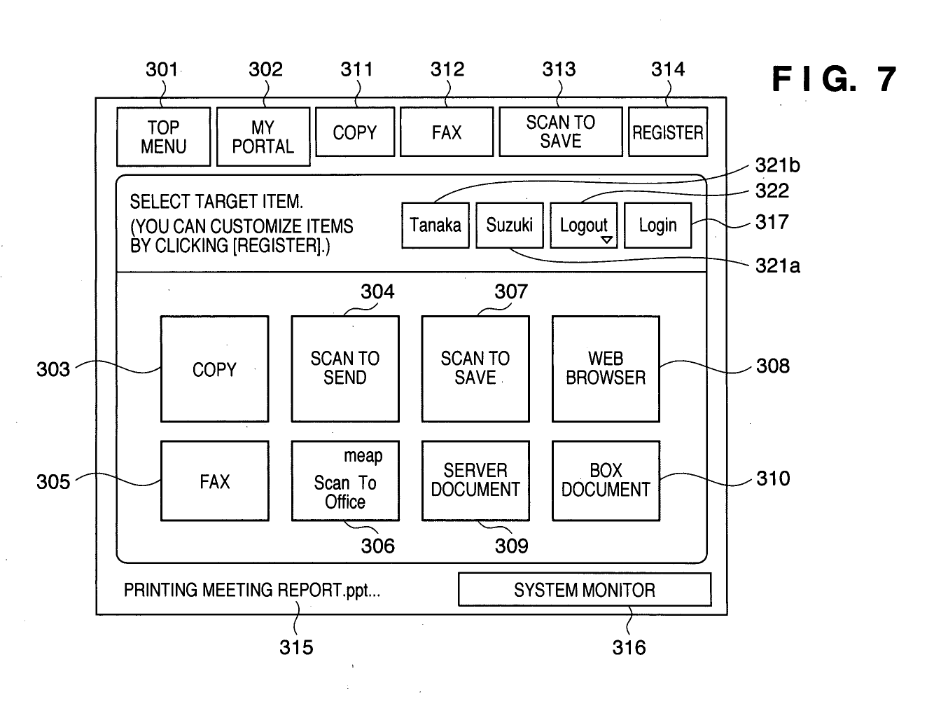

FIG. 7 is a view showing an example of an operation window displayed on the liquid crystal display of the operation unit 30 after a plurality of login processes is executed via the operation window shown in FIG. 5 (i.e., after a plurality of users log in to the image forming apparatus 1). The operation window shown in FIG. 7 is a transition operation window from the operation window shown in FIG. 6. The operation window shown in FIG. 7 is basically the same as that shown in FIG. 6 except that information 321b of a user (“tanaka” in the embodiment) who has newly logged in is displayed in addition to the information 321a of the user (“suzuki”) who has already logged in to the image forming apparatus 1. In the operation window shown in FIG. 7, the logout key 322 is a pull-down menu. The logout key 322 displays a plurality of users who have logged in to the image forming apparatus 1, so as to be able to select a user who is to log out. The logout key 322 accepts an operation to select a user who is to log out.

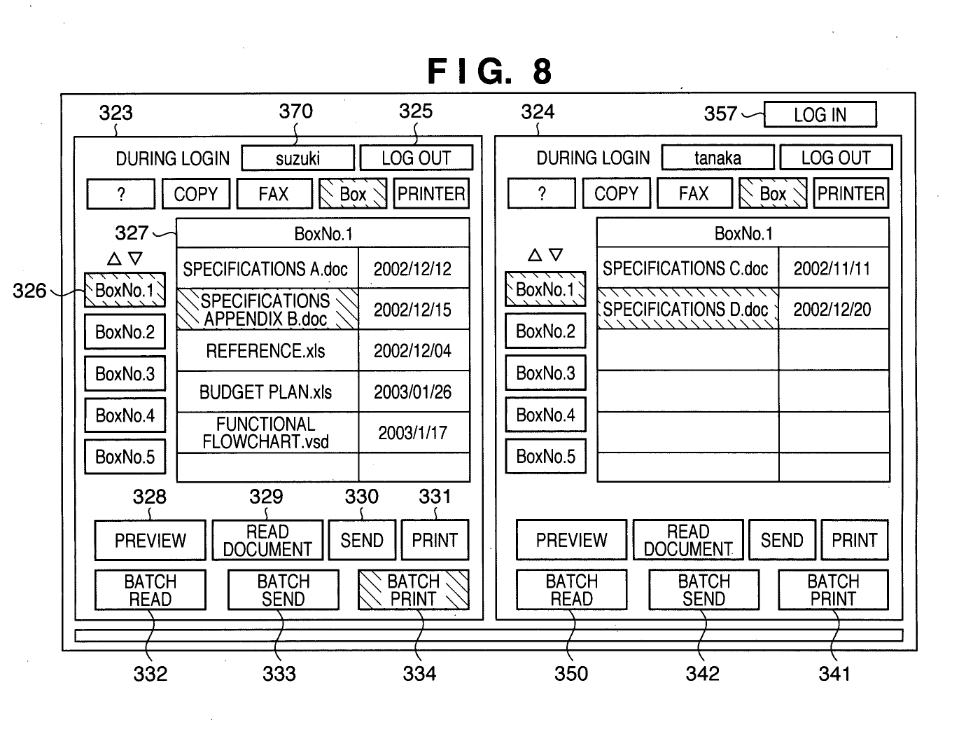

FIG. 8 is a view showing an example of an operation window displayed on the liquid crystal display of the operation unit 30 when one of the job keys 303 to 310 and shortcut keys 311 to 313 is pressed in the operation window shown in FIG. 7. The embodiment will exemplify a case wherein the box document (Box function) job key 310 is pressed in the operation window shown in FIG. 7. The operation window shown in FIG. 8 displays a plurality of panes (areas assigned to respective users) corresponding to respective users. In the embodiment, a pane 323 corresponding to user “suzuki”, and a pane 370 corresponding to user “tanaka” are displayed.

In FIG. 8, a field 370 displays information of user “suzuki” who is the owner of the pane 323. By pressing a logout key 325, user “suzuki” can log out. Each field 326 displays a Box number so as to be able to select each Box number. A field 327 displays document data (image data) saved in a box corresponding to a Box number (“Box No. 1” in the embodiment) selected in the Box number field 326. The field 327 displays document data so as to be able to select each document data. In the field 327, selected document data is hatched as shown in FIG. 8. In the embodiment, “specifications appendix B.doc” is selected.

Keys 328 to 334 are used to designate execution of various processes (jobs) by a user corresponding to the pane 323 as a job owner. The keys 328 to 331 are used to process document data displayed in the pane 323. The keys 332 to 334 are used to process document data displayed in the panes 323 and 324 (i.e., all panes displayed in the operation window). For example, when the preview key 328 is pressed, user “suzuki” who is the owner of the pane 323 serves as a job owner, and “specifications appendix B.doc” selected in the pane 323 is previewed. When the “read document” key 329 is pressed, user “suzuki” who is the owner of the pane 323 serves as a job owner, and the reader unit 10 reads a document. Image data obtained by this operation is newly saved in a box corresponding to Box No. 1 selected in the pane 323. When the send key 330 is pressed, user “suzuki” who is the owner of the pane 323 serves as a job owner, and “specifications appendix B.doc” selected in the pane 323 is sent to a designated destination. When the print key 331 is pressed, user “suzuki” who is the owner who is the owner of the pane 323 serves as a job owner, and “specifications appendix B.doc” selected in the pane 323 is printed.

The pane 324 whose owner is user “tanaka” has the same arrangement as that of the pane 323 whose owner is user “suzuki”, and a detailed description thereof will not be repeated. More specifically, keys which are displayed in the pane 324 and designate execution of various processes are used for a user corresponding to the pane 324 serving as a job owner. In the pane 324, document data “specifications D.doc” is selected.

In the operation window shown in FIG. 8, when the batch print key 334 in the pane 323 is pressed, the document data “specifications appendix B.doc” selected in the pane 323 and the document data “specifications D.doc” selected in the pane 324 are printed. At this time, user “suzuki” serves as a job owner.

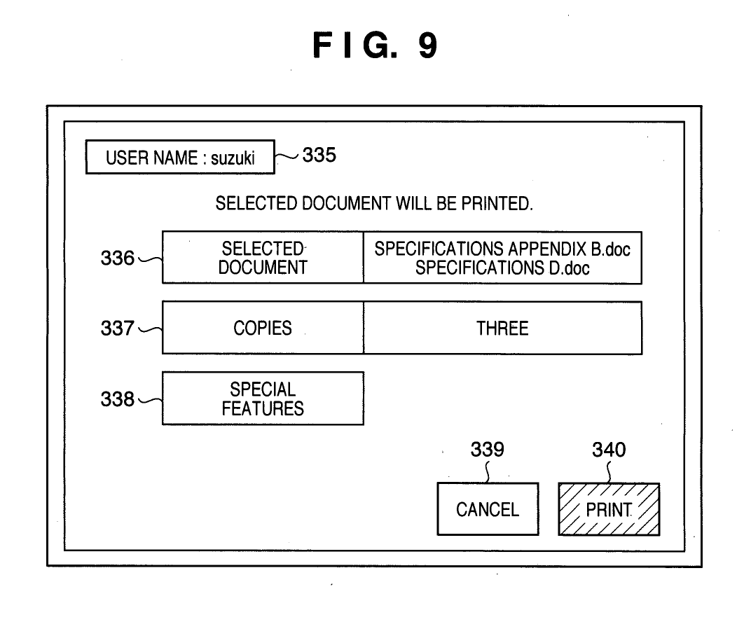

FIG. 9 is a view showing an example of an operation window displayed on the liquid crystal display of the operation unit 30 when the batch print key 334 in the pane 323 is pressed in the operation window shown in FIG. 8. In the operation window shown in FIG. 9, a field 335 for displaying a job owner displays user “suzuki” to represent that user “suzuki” executes a job (print).

In FIG. 9, a field 336 displays selected document data, and in the embodiment, displays “specifications appendix B.doc” and “specifications D.doc”. A field 337 displays the number of copies of document data, and in the embodiment, displays “three” copies. A key 338 is used to designate special features for making various settings such as double-sided printing. When the key 338 is pressed, a window for making various settings such as double-sided printing appears. A key 339 is pressed to cancel printing. A key 340 is pressed to execute printing. In the embodiment, when the key 340 is pressed, user “suzuki” serves as a job owner, and “specifications appendix B.doc” and “specifications D.doc” are printed by three copies. When setting user “tanaka” as a job owner, a batch print key 341 in the pane 324 whose owner is user “tanaka” suffices to be pressed in the operation window shown in FIG. 8.

When the batch send key 333 in the pane 323 is pressed in the operation window shown in FIG. 8, the document data “specifications appendix B.doc” selected in the pane 323 and the document data “specifications D.doc” selected in the pane 324 are sent to a designated destination. At this time, user “suzuki” serves as a job owner. When setting user “tanaka” as a job owner, a batch send key 342 in the pane 324 whose owner is user “tanaka” suffices to be pressed.

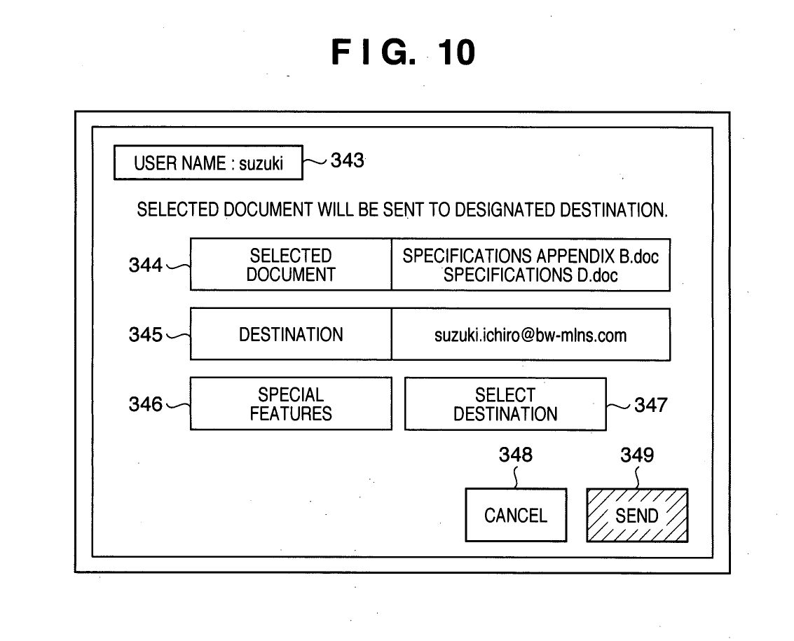

FIG. 10 is a view showing an example of an operation window displayed on the liquid crystal display of the operation unit 30 when the batch send key 333 in the pane 323 is pressed in the operation window shown in FIG. 8. In the operation window shown in FIG. 10, a field 343 for displaying a job owner displays user “suzuki” to represent that user “suzuki” executes a job (send).

In FIG. 10, a field 344 displays selected document data, and in the embodiment, displays “specifications appendix B.doc” and “specifications D.doc”. A field 345 displays a destination to which document data is to be sent, and in the embodiment, displays “suzuki.ichiro@bw-mlns.com”. A key 346 is used to designate special features for making various settings such as resolution. When the key 346 is pressed, a window for setting the resolution and the like of image data to be sent appears. A key 347 is used to select (set) a destination to which document data is to be sent. When the key 347 is pressed, a destination in an address book stored in the image forming apparatus 1 or a directly input destination can be selected. A key 348 is pressed to cancel sending. A key 349 is pressed to execute sending. In the embodiment, when the key 349 is pressed, user “suzuki” serves as a job owner, and “specifications appendix B.doc” and “specifications D.doc” are sent to “suzuki.ichiro@bw-mlns.com”.

Assume that the batch read key 332 in the pane 323 is pressed in the operation window shown in FIG. 8. In this case, image data read from the reader unit 10 is saved as new document data in boxes corresponding to Box numbers respectively selected in the pane 323 whose owner is user “suzuki” and the pane 324 whose owner is user “tanaka”. At this time, user “suzuki” serves as a job owner. When setting user “tanaka” as a job owner, a batch read key 350 in the pane 324 whose owner is user “tanaka” suffices to be pressed.

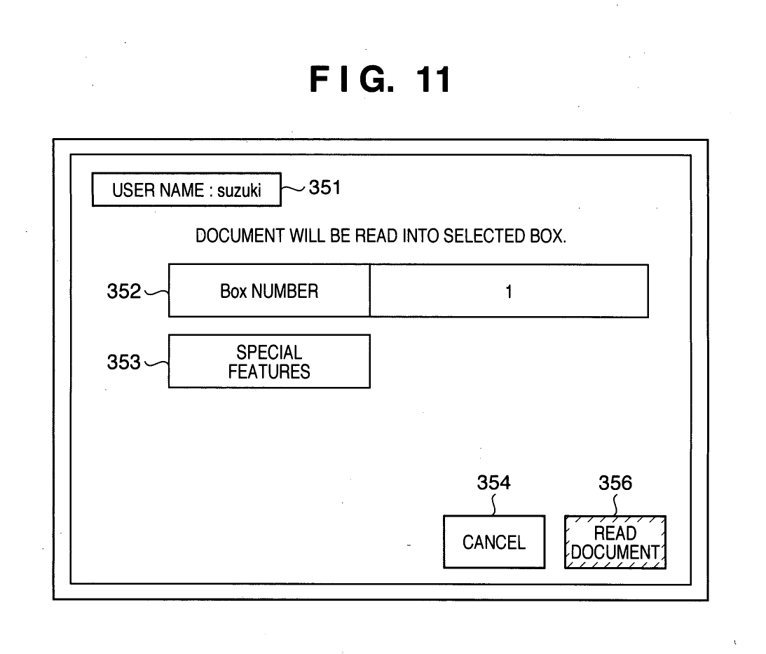

FIG. 11 is a view showing an example of an operation window displayed on the liquid crystal display of the operation unit 30 when the batch read key 332 in the pane 323 is pressed in the operation window shown in FIG. 8. In the operation window shown in FIG. 11, a field 351 for displaying a job owner displays user “suzuki” to represent that user “suzuki” executes a job (read).

In FIG. 11, a field 352 displays a Box number for saving new document data, and in the embodiment, displays “1”. A key 353 is used to designate special features for making various settings such as resolution. A key 354 is pressed to cancel reading. A key 355 is pressed to execute reading. In the embodiment, when the key 355 is pressed, user “suzuki” serves as a job owner, and new document data is saved in boxes corresponding to “Box No. 1” in the panes 323 and 324.

When setting, as a job owner, a user (a user other than users “suzuki” and “tanaka” in the embodiment) who does not log in to the image forming apparatus 1, a login key 357 suffices to be pressed in the operation window shown in FIG. 8. In this case, the liquid crystal display of the operation unit 30 displays the operation window (login window) shown in FIG. 5. When not a user name but a department ID (e.g., “1234”) is input in the input field 318 in the operation window shown in FIG. 5, the user can log in to the image forming apparatus 1 using the department ID “1234”. In the embodiment, the operation unit 30 displays panes corresponding to respective users, and thus displays a pane whose owner is one corresponding to the department ID “1234”, in addition to the panes 323 and 324 whose owners are users “suzuki” and “tanaka”.

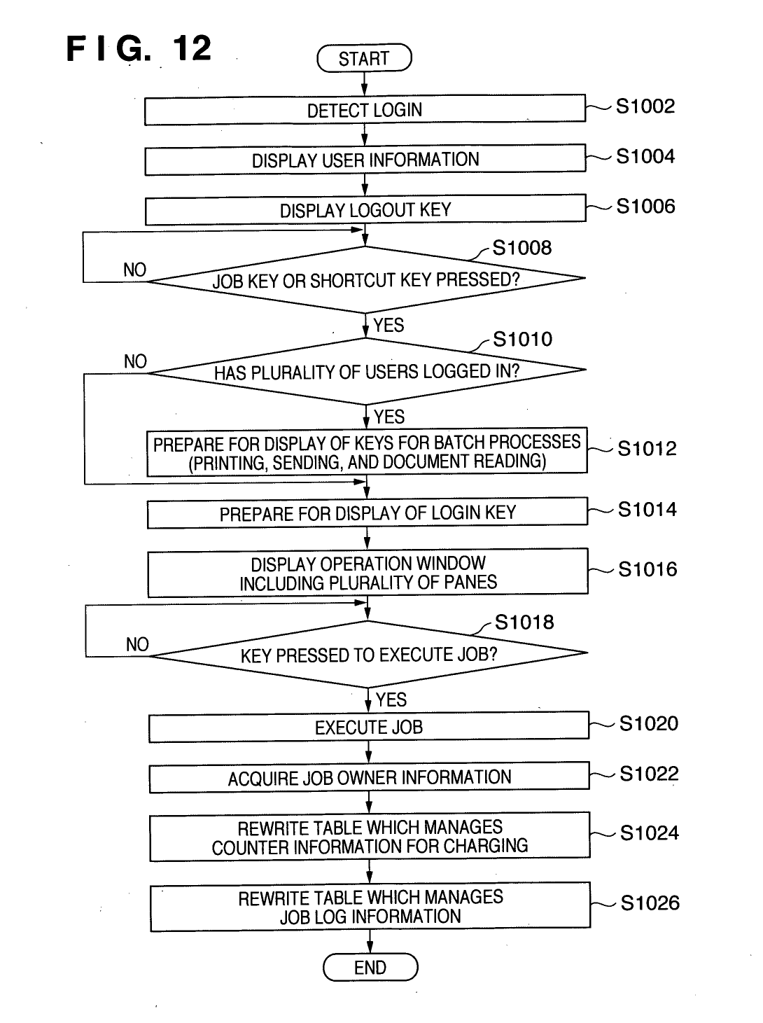

The operation of the image forming apparatus 1 will be explained. FIG. 12 is a flowchart for explaining the operation of the image forming apparatus 1.

In step S1002, the control unit 50 detects that a user has logged in to the image forming apparatus 1. The user can log in to the image forming apparatus 1 by operating the above-described operation windows shown in FIG. 4 (or FIG. 6 or 7) and FIG. 5. The embodiment explains the operation on the premise that a user logs in to the image forming apparatus 1. In practice, it is detected whether a user has logged in to the image forming apparatus 1.

In step S1004, the control unit 50 displays, on the liquid crystal display of the operation unit 30, information (e.g., the user information 321a in the operation window shown in FIG. 6) of the user detected in step S1002 to have logged in.

In step S1006, the control unit 50 displays, on the liquid crystal display of the operation unit 30, a logout key (e.g., the logout key 322 in the operation window shown in FIG. 6) for allowing the user, who is detected in step S1002 to have logged in, to log out.

After steps S1004 and S1006, the liquid crystal display of the operation unit 30 displays the operation window shown in FIG. 6. When another user has already logged in to the image forming apparatus 1, the liquid crystal display of the operation unit 30 displays the operation window shown in FIG. 7.

In step S1008, the control unit 50 monitors whether a job key (e.g., one of the job keys 304 to 310 in the operation window shown in FIG. 6) or a shortcut key (e.g., one of the shortcut keys 311 to 313 in the operation window shown in FIG. 6) has been pressed.

If the control unit 50 determines in step S1008 that neither a job key nor shortcut key has been pressed, it keeps monitoring until a job key or shortcut key is pressed. If the control unit 50 determines in step S1008 that a job key or shortcut key has been pressed, the process advances to step S1010.

In step S1010, the control unit 50 determines whether a plurality of users has simultaneously logged in to the image forming apparatus 1. As a method of determining whether a plurality of users has logged in, the control unit 50 can employ a variety of methods. For example, whether a plurality of users has logged in may be determined from information of logged-in users. Whether a plurality of users has logged in may also be determined from the count (e.g., the count at which users were authenticated) at which login processing has been executed while no logged-in user has logged out.

If the control unit 50 determines in step S1010 that a plurality of users has not logged in (i.e., only one user has logged in), the process advances to step S1014. If the control unit 50 determines in step S1010 that a plurality of users has logged in, the process advances to step S1012. A case wherein a plurality of users has logged in to the image forming apparatus 1 will be exemplified.

In step S1012, the control unit 50 prepares for display of keys (e.g., the keys 332 to 334, 341, 342, and 350 in the operation window shown in FIG. 8) for executing batch processes such as batch reading, batch sending, and batch printing in the pane of each user.

In step S1014, the control unit 50 prepares for display of a login key (e.g., the login key 357 shown in FIG. 8) for allowing a user who has not logged in to the image forming apparatus 1 to log in.

In step S1016, the control unit 50 displays, on the liquid crystal display of the operation unit 30, an operation window including a plurality of panes corresponding to respective users who have logged in to the image forming apparatus 1. Each of the panes includes keys prepared in step S1012 to execute batch processes. The operation window including these panes includes a login key prepared in step S1014.

After steps S1012 to S1016, the liquid crystal display of the operation unit 30 displays the operation window shown in FIG. 8. When only one user has logged in to the image forming apparatus 1, for example, an operation window (single-pane operation window) including only the pane 323 in the operation window shown in FIG. 8 appears. This operation window does not display keys (keys prepared in step S1012) for executing batch processes.

In step S1018, the control unit 50 monitors whether a key for executing a job (e.g., one of the keys 328 to 331 for executing processes and the keys 332 to 334 for executing batch processes in the operation window shown in FIG. 8) has been pressed.

If the control unit 50 determines in step S1018 that a key for executing a job has not been pressed, it keeps monitoring until a key for executing a job is pressed. If the control unit 50 determines in step S1018 that a key for executing a job has been pressed, the process advances to step S1020.

In step S1020, the control unit 50 controls the reader unit 10, printer unit 20, storage unit 40, and the like to execute a job corresponding to the key determined in step S1018 to have been pressed.

In step S1022, the control unit 50 acquires, based on an operation on the operation unit 30, information of a user (job owner) who has executed the job. For example, when the key 334 is pressed in the operation window shown in FIG. 8, the control unit 50 can acquire information representing that the job owner is “suzuki” and the job is “batch printing”. That is, a pane in which a displayed key has been pressed is determined to identify a user, and accept an instruction to execute a job corresponding to the pressed key. Then, a job corresponding to the contents of the pressed key is executed as a job by the user.

In step S1024, based on the job owner information acquired in step S1022, the control unit 50 rewrites a table (see FIG. 2) which is stored in the storage unit 40 and manages counter information for charging. For example, when the key 334 for executing batch printing is pressed, the count at which user “suzuki” executed “Box print” is incremented (from 15 to 16) in the table 420 shown in FIG. 2.

In step S1026, based on the job execution result in step S1020 and the job owner information acquired in step S1022, the control unit 50 rewrites a table (see FIG. 3) which is stored in the storage unit 40 and manages job log information.

In this manner, according to the embodiment, the operation unit 30 displays an operation window including a plurality of panes corresponding to respective users who have logged in to the image forming apparatus 1. A user (job owner) who is to execute a job is identified based on an operation on the operation unit 30. Hence, the image forming apparatus 1 can definitely identify a job owner in an environment where a plurality of users can log in. The image forming apparatus 1 can solve the problem that no correct job owner is stored in a table which manages information on jobs, and the problem that a third party user (account) is charged. In this case, keys for issuing job execution instructions are displayed in a pane corresponding to each user. A user who is to execute a job can be identified based on the display.

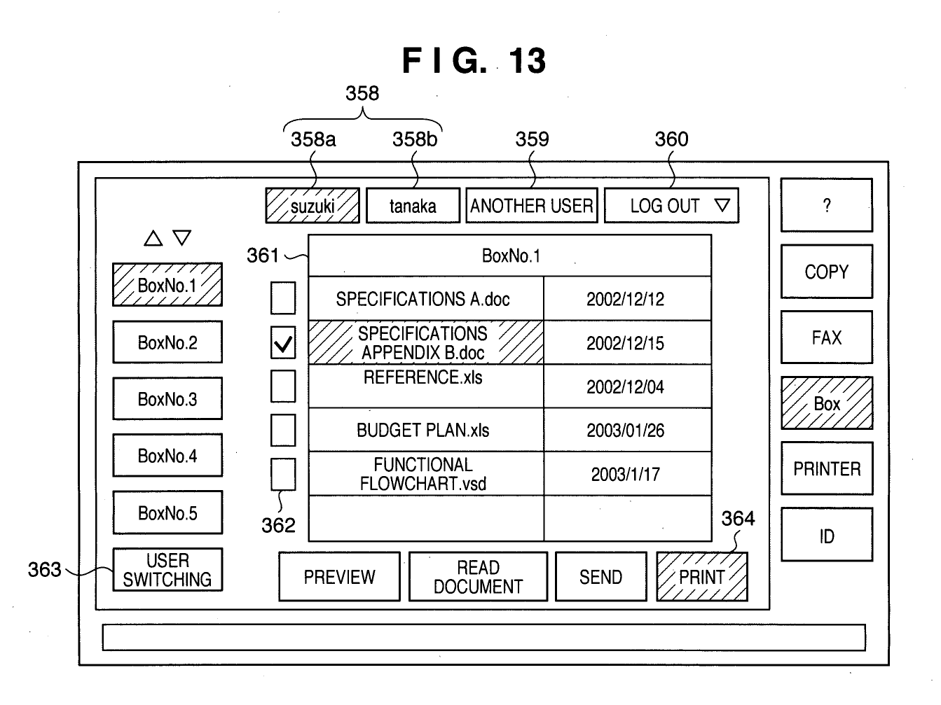

Even when a plurality of users log in to the image forming apparatus 1, an operation window can also be displayed with a single pane, as shown in FIG. 13. FIG. 13 is a view showing an example of an operation window displayed on the liquid crystal display of the operation unit 30 when one of the job keys 303 to 310 and shortcut keys 311 to 313 is pressed in the operation window shown in FIG. 7. A case wherein the box document (Box function) job key 310 is pressed in the operation window shown in FIG. 7 will be exemplified. In the operation window shown in FIG. 13, a single pane represents that a plurality of users has logged in to the image forming apparatus 1.

In FIG. 13, a field 358 displays information of users who have logged in to the image forming apparatus 1. In the embodiment, fields 358a and 358b represent that users “suzuki” and “tanaka” have logged in. The field 358 which displays user information includes identification information for identifying the owner of a single pane displayed in the operation window. For example, in the embodiment, user “suzuki” displayed in the field 358a is hatched to represent that the owner of the pane in the operation window shown in FIG. 13 is user “suzuki”. An “another user” key 359 is pressed to allow a user, who has not logged in to the image forming apparatus 1, to log in. A logout key 360 is pressed to allow a user, who has logged in to the image forming apparatus 1, to log out. When a plurality of users has logged in to the image forming apparatus 1, the logout key 360 displays a plurality of users who has logged in to the image forming apparatus 1, so as to be able to select a user who is to log out. Then, the logout key 360 accepts an operation to select a user who is to log out. A field 361 displays document data saved in a box corresponding to a selected Box number (“Box No. 1” in the embodiment). The field 361 displays document data so as to be able to select each document data. In the operation window shown in FIG. 13, “specifications appendix B.doc” is selected. A check box 362 is used to designate document data to undergo batch processing. In the operation window shown in FIG. 13, “specifications appendix B.doc” is designated as a target to undergo batch processing. A user switching key 363 is used to switch a user displayed in the pane. By pressing the user switching key 363, the owner of the pane displayed in the operation window can be switched. Keys 364 are used to execute various processes (jobs). For example, when the key 364 for executing print processing is pressed in the operation window shown in FIG. 13, user “suzuki” who is the owner of the pane 323 serves as a job owner, and print processing (including batch processing) is executed.

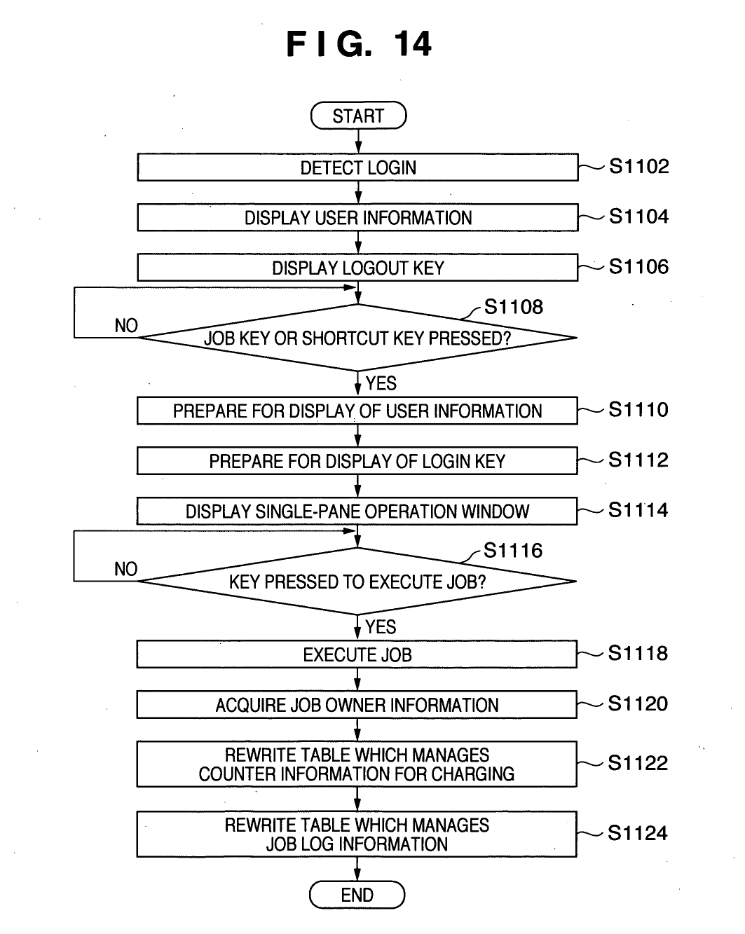

The operation of the image forming apparatus 1 when displaying an operation window with a single pane will be explained. FIG. 14 is a flowchart for explaining the operation of the image forming apparatus 1.

In step S1102, the control unit 50 detects that a user has logged in to the image forming apparatus 1. The embodiment explains the operation on the premise that a user logs in to the image forming apparatus 1. In practice, it is detected whether a user has logged in to the image forming apparatus 1.

In step S1104, the control unit 50 displays, on the liquid crystal display of the operation unit 30, information (e.g., the user information 321a in the operation window shown in FIG. 6) of the user detected in step S1102 to have logged in.

In step S1106, the control unit 50 displays, on the liquid crystal display of the operation unit 30, a logout key (e.g., the logout key 322 in the operation window shown in FIG. 6) for allowing the user, who is detected in step S1102 to have logged in, to log out.

After steps S1104 and S1106, the liquid crystal display of the operation unit 30 displays the operation window shown in FIG. 6. When another user has already logged in to the image forming apparatus 1, the liquid crystal display of the operation unit 30 displays the operation window shown in FIG. 7.

In step S1108, the control unit 50 monitors whether a job key (e.g., one of the job keys 304 to 310 in the operation window shown in FIG. 6) or a shortcut key (e.g., one of the shortcut keys 311 to 313 in the operation window shown in FIG. 6) has been pressed.

If the control unit 50 determines in step S1108 that neither a job key nor shortcut key has been pressed, it keeps monitoring until a job key or shortcut key is pressed. If the control unit 50 determines in step S1108 that a job key or shortcut key has been pressed, the process advances to step S1110.

In step S1110, the control unit 50 prepares for display of information (e.g., the field 358 for displaying user information in the operation window shown in FIG. 13) of the user who has logged in to the image forming apparatus 1.

In step S1112, the control unit 50 prepares for display of a login key (e.g., the “another user” key 359 in the operation window shown in FIG. 13) for allowing a user who has not logged in to the image forming apparatus 1 to log in.

In step S1114, the control unit 50 displays, on the liquid crystal display of the operation unit 30, an operation window of a single pane including the user information and login key prepared in steps S1110 and S1112.

After steps S1110 to S1114, the liquid crystal display of the operation unit 30 displays the operation window shown in FIG. 13.

In step S1116, the control unit 50 monitors whether a key for executing a job (e.g., the key 364 for executing various processes in the operation window shown in FIG. 13) has been pressed.

If the control unit 50 determines in step S1116 that a key for executing a job has not been pressed, it keeps monitoring until a key for executing a job is pressed. If the control unit 50 determines in step S1116 that a key for executing a job has been pressed, the process advances to step S1118.

In step S1118, the control unit 50 controls the reader unit 10, printer unit 20, storage unit 40, and the like to execute a job corresponding to the key determined in step S1116 to have been pressed.

In step S1120, the control unit 50 acquires, based on an operation on the operation unit 30, information of a user (job owner) who has executed the job. For example, when the key 364 is pressed in the operation window shown in FIG. 13, identification information (hatched) represents user “suzuki”, and thus the control unit 50 can acquire information representing that the job owner is “suzuki” and the job is “printing”. At this time, it is also possible to provide a display which prompts a user to confirm that the job owner is “suzuki”, and if the user sends back an instruction representing “OK”, start execution of the job.

In step S1122, based on the job owner information acquired in step S1120, the control unit 50 rewrites a table (see FIG. 2) which is stored in the storage unit 40 and manages counter information for charging.

In step S1124, based on the job execution result in step S1118 and the job owner information acquired in step S1120, the control unit 50 rewrites a table (see FIG. 3) which is stored in the storage unit 40 and manages job log information.

In this way, even when a plurality of users has logged in to the image forming apparatus 1 and the operation unit 30 displays a single-pane operation window, a user (job owner) who is to execute a job can be identified based on an operation on the operation unit 30. However, a single pane needs to include identification information of a user who is to execute a job. In this example, a job is executed upon identifying a job owner on the basis of display of user information. Hence, an execution instruction can also be issued with hard keys, instead of keys displayed in the operation window.

The above-described embodiment can be implemented by software by the computer (or the CPU or MPU) of the system or apparatus.

To implement the above-described embodiment by the compute, a computer program supplied to the computer also implements the present invention. In other words, a computer program for implementing the functions of the above-described embodiment also constitutes one aspect of the present invention.

The computer program for implementing the above-described embodiment can take any form as long as it is computer-readable. For example, the computer program can be formed from an object code, a program executed by an interpreter, script data supplied to the OS, or the like. However, the computer program is not limited to them.

The computer program for implementing the above-described embodiment is supplied to the computer by a storage medium or wired/wireless communication. Examples of the storage medium for supplying the program are a magnetic storage medium (e.g., a flexible disk, hard disk, or magnetic tape), an optical/magneto-optical storage medium (e.g., a MO, CD, or DVD), and a nonvolatile semiconductor memory.

As the computer program supply method using wired/wireless communication, a server on a computer network is used. In this case, the server stores a data file (program file) serving as the computer program which constitutes the present invention. The program file may be an executable program or source code.

The server supplies the program file by downloading to a client computer which accesses the server. In this case, it is also possible to divide the program file into a plurality of segment files, and store the segment files in different servers.

Hence, even the server which provides a client computer with the program file for implementing the above-described embodiment also constitutes one aspect of the present invention.

It is also possible to encrypt the computer program for implementing the above-described embodiment, distribute a storage medium which stores the encrypted computer program, supply decryption key information to a user who satisfies a predetermined condition, and permit him to install the computer program in his computer. The key information can be supplied by, for example, downloading it from a homepage via the Internet.

The computer program for implementing the above-described embodiment may also use the function of an OS running on the computer.

The computer program for implementing the above-described embodiment may also be partially formed from firmware such as an expansion board mounted in a computer, or executed by the CPU of the expansion board or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-081743 filed Mar. 26, 2008, which is hereby incorporated by reference herein in its entirety.

1. A job processing apparatus which allows a plurality of users to log in, the apparatus comprising:
a detection means configured to detect that a plurality of users has logged in;
an accepting means configured to accept a job execution instruction from a user;
a display means configured to, when said detection means detects that a plurality of users has logged in, display the plurality of logged-in users so as to be able to identify a user who issues a job execution instruction to be accepted by said accepting means, among the plurality of logged-in users; and
a processing means configured to, when the user is identified based on the display by said display means and said accepting means accepts the job execution instruction, execute a job corresponding to the execution instruction as a job by the identified user.

2. The apparatus according to claim 1, further comprising:
a storage means configured to store a table which manages information on the job for each user; and
a rewrite means configured to rewrite the information of a user identified in accordance with execution of the job by said processing means.

3. The apparatus according to claim 2, wherein the information includes a count at which the job was executed.

4. The apparatus according to claim 1, wherein
said display means selectively displays a user who is to log out from the plurality of logged-in users, and
said accepting means accepts an operation to select a user who is displayed on said display means and is to log out.

5. The apparatus according to claim 1, wherein
said display means displays a plurality of areas corresponding to the plurality of logged-in users, respectively, and
each of the plurality of areas includes information on a corresponding user among the plurality of logged-in users, and a key used to input the job execution instruction.

6. The apparatus according to claim 5, wherein said processing means identifies, based on information on a user corresponding to an area where the key is pressed, a user who is to execute the job.

7. The apparatus according to claim 1, wherein said display means selectively displays pieces of identification information for identifying the plurality of logged-in users.

8. The apparatus according to claim 7, wherein said processing means identifies, based on the selected identification information, a user who is to execute the job.

9. A control method for a job processing apparatus which allows a plurality of users to log in, the method comprising:
a detection step of detecting that a plurality of users has logged in;
an accepting step of accepting a job execution instruction from a user;
a display step of, when a plurality of users is detected in the detection step to have logged in, causing a display means to display the plurality of logged-in users so as to be able to identify a user who issues a job execution instruction to be accepted in the accepting step, among the plurality of logged-in users; and
a processing step of, when the user is identified based on the display in the display step and the job execution instruction is accepted in the accepting step, executing a job corresponding to the execution instruction as a job by the identified user.

10. A storage medium which stores a program for causing a computer to execute a control method for a job processing apparatus which allows a plurality of users to log in, the program causing the computer to execute
a detection step of detecting that a plurality of users has logged in,
an accepting step of accepting a job execution instruction from a user,
a display step of, when a plurality of users is detected in the detection step to have logged in, causing a display means to display the plurality of logged-in users so as to be able to identify a user who issues a job execution instruction to be accepted in the accepting step, among the plurality of logged-in users, and
a processing step of, when the user is identified based on the display in the display step and the job execution instruction is accepted in the accepting step, executing a job corresponding to the execution instruction as a job by the identified user.
